(19) United States
(12) Patent Application Publication
(10) Pub. No.: US 2013/0254899 A1
(43) Pub. Date: Sep. 26, 2013

(54) DATA PROTECTING SYSTEM AND PROTECTING METHOD

(71) Applicant: Xin GUO, Shenzhen City (CN)

(72) Inventor: Xin GUO, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/459,102

(22) Filed: Apr. 28, 2012

(30) Foreign Application Priority Data
Mar. 23, 2012 (CN) 201210081656.1

(51) Int. Cl. G06F 21/24

(52) U.S. Cl. 726/28

(57) ABSTRACT

A data protecting method implemented by an electronic device includes periodically obtaining current environmental characteristics around the electronic device and store the current environmental characteristics in a memory; comparing the current environmental characteristics with previous environmental characteristics to determine whether the current environmental characteristics change; obtaining user characteristics of a user when the environmental characteristics changes; comparing the user characteristics with authorized users' user characteristics to determine if the user is authorized, and implementing data protection when the user is unauthorized. A data protecting system is also provided.

### BACKGROUND

1. Technical Field

The present disclosure relates to a data protecting system and a protecting method used by the data protecting system.

2. Description of Related Art

Mobile phones and tablet PCs are often used as portable storage devices, which record important documents and personal information. However, mobile phones and tablet PCs only use password to protect the important documents and personal information. If the password is cracked, the important documents and personal information can be accessed by others, which is disadvantageous and may result in great loss.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a data protecting system, in accordance with the present disclosure.

FIG. 2 is a flowchart of an embodiment of data protecting method implemented by the data protecting system in FIG. 1, in accordance with the present disclosure.

FIG. 3 is a flowchart of an embodiment of data protecting procedure of step S25 in FIG. 2.

### DETAILED DESCRIPTION

Embodiments of the present disclosure will be described with reference to the accompanying drawings.

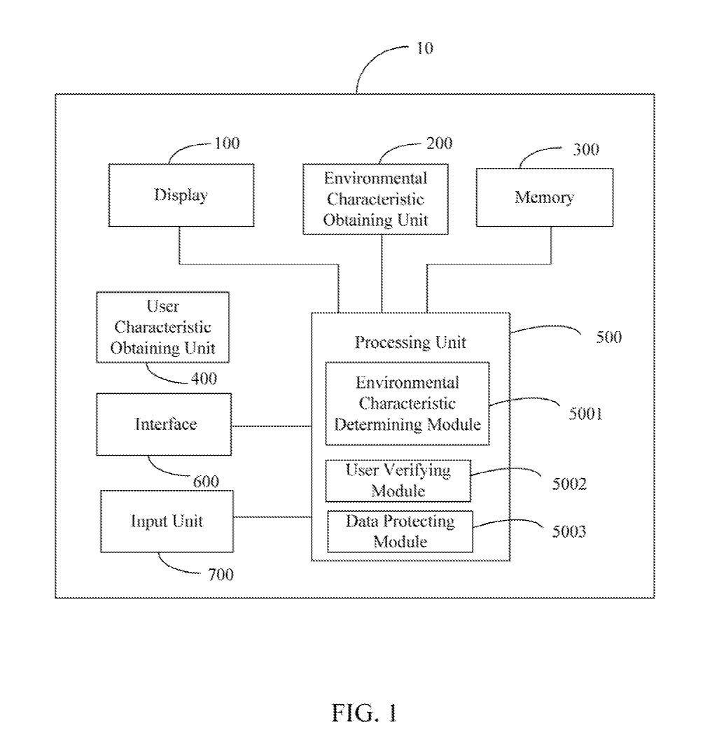

FIG. 1 is a block diagram of an embodiment of a data protecting system, in accordance with the present disclosure. The data protecting system can be run on an electronic device 10. The electronic device 10 may be a mobile phone or a tablet PC. The electronic device 10 includes a display 100, an environmental characteristic obtaining unit 200, a memory 300, a user characteristic obtaining unit 400, a processing unit 500, an interface 600, and an input unit 700.

The display 100 is used to display a number of multimedia files.

The environmental characteristic obtaining unit 200 is set in the electronic device 10, for periodically obtain current environmental characteristics around the electronic device 10, such as levels of ambient light, and store the current environmental characteristics in the memory 300. The environmental characteristic obtaining unit 200 may be a brightness obtaining unit to detect the current levels of ambient light, and store the current levels of ambient light in the memory 300.

The memory 300 is configured to supply space to store displayable media such as audio files and text.

The user characteristic obtaining unit 400 is used to obtain user characteristics of a user such as fingerprints and/or facial features when the environmental characteristic changes. The user characteristic obtaining unit 400 may be a camera, for shooting images of the user's fingerprint and/or facial features. The memory 300 is also used to store a number of authorized users' user characteristics such as the fingerprints and/or facial features.

The interface 600 can be a wired interface (such as the USB interface, etc.) or a wireless interface (such as a wireless communication module) to realize the connection between the electronic device 10 and other electronic devices.

The input unit 700 is configured to receive user input. The user input unit 80 can be input keys/buttons, knobs, and the like.

The processing unit 500 compares the current environmental characteristics with previously environmental characteristics to determine whether the current environmental characteristics have changed, controls the user characteristic obtaining unit 400 to obtain user characteristics of the user when the environmental characteristics have changed, compares the user characteristics with authorized users' user characteristics stored in the memory 300 to determine if the user is authorized, and implements data protection when the user is unauthorized. In another embodiment, the authorized users' user characteristics can also be stored in a network server which can be obtained via network. For example, supposing the user characteristics are fingerprints, and the authorized users' fingerprints are pre-stored in the memory 300, the processing unit 500 obtains the fingerprints of the user, compares the fingerprints of the user with the authorized users' fingerprints which are pre-stored in the memory, if the fingerprints of the user is consistent with the authorized users' fingerprints, the user is determined to be authorized, otherwise the user is determined to be unauthorized.

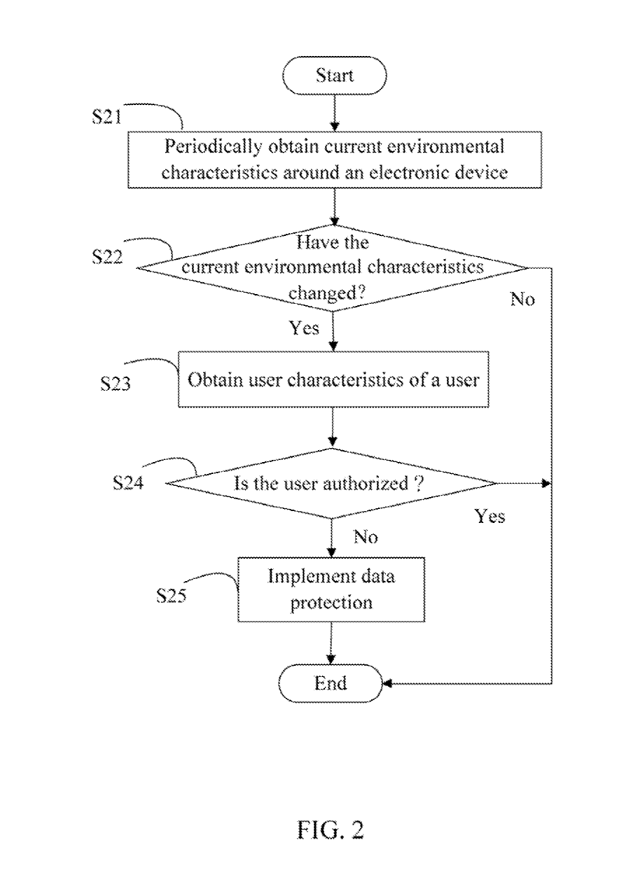

The processing unit 500 includes an environmental characteristic determining module 5001, a user verifying module 5002 and a data protecting module 5003. The functions of the modules will be described with reference to FIG. 2.

FIG. 2 is a flowchart of an embodiment of data protecting method implemented by the data protecting system in FIG. 1, in accordance with the present disclosure.

In step S21, the environmental characteristic obtaining unit 200 periodically obtains current environmental characteristics around the electronic device 10, such as the current levels of ambient light, and stores the current environmental characteristics in the memory 300.

In step S22, the environmental characteristic determining module 5001 compares the current environmental characteristics with previously environmental characteristics to determine whether the current environmental characteristics have changed. If yes, the procedure ends, if no, the procedure goes to S23.

In step S23, the user characteristic obtaining unit 400 obtains user characteristics of the user such as fingerprints and/or facial features.

In step S24, the user verifying module 5002 compares the obtained user characteristics with authorized users' user characteristics stored in the memory 300 to determine if the user is authorized. If yes, the procedure ends, if no, the procedure goes to S25.

In step S25, the data protecting module 5003 implements data protection.

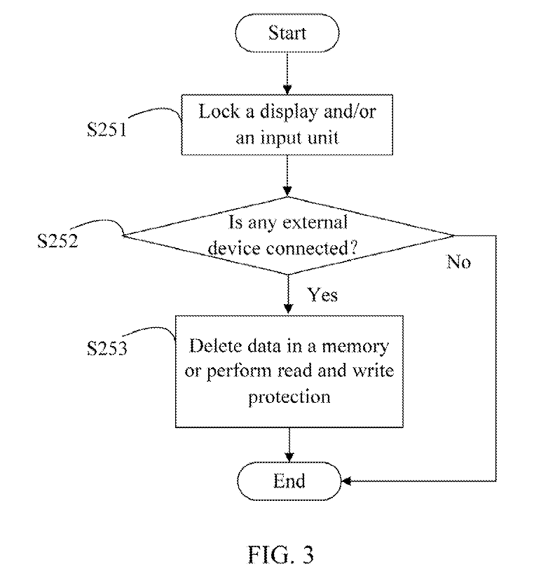

FIG. 3 is a flowchart of an embodiment of performing data protecting procedure of step S25 in FIG. 2.

In step S251, the data protecting module 5003 locks the display 100 and/or the input unit 700 such as keys/buttons to prevent any operation by the user.

In step S252, the data protecting module 5003 determines if any external device is connected with the interface 600, if yes, the procedure goes to step S253, if no, the procedure ends.

In step S253, the data protecting module 5003 deletes the data in the memory 300 or performs read and write protection of the data in the memory 300, then the procedure ends.

Though above system and method, the electronic device 10 determines if the user can be regarded as authorized when the current environmental characteristics change, and protects the data in memory 300 when the user is regarded as unauthorized, which is effective and easy to implement.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A data protecting system applied on an electronic device, the data protecting system comprising:
a memory;
an environment characteristic obtaining unit, to periodically obtain current environmental characteristics around the electronic device and store the current environmental characteristics in the memory;
a user characteristic obtaining unit, to obtain user characteristics of a user when the environmental characteristics changes; and
a processing unit, comprising an environmental characteristic determining module, a user verifying module and a data protecting module;
wherein the environmental characteristic determining module compares the current environmental characteristics with previous environmental characteristics to determine whether the current environmental characteristics change,
wherein the user verifying module controls the user characteristic obtaining unit to obtain user characteristics when the current environmental characteristics have changed, and compares the user characteristics with authorized users' user characteristics to determine if the user is authorized, and
wherein the data protecting module implements data protection when the user is unauthorized.

2. The data protecting system of claim 1, further comprising a display and/or an input unit, wherein the data protecting module locks the display and/or the input unit to prevent any operation by the user.

3. The data protecting system of claim 1, further comprising a memory and an interface, wherein the data protecting module deletes the data in the memory or perform read and write protection of the data in the memory if any external device is connected with the interface.

4. The data protecting system of claim 1, wherein the current environmental characteristics are levels of ambient light.

5. The data protecting system of claim 4, wherein the environmental characteristic obtaining unit is a brightness obtaining unit to detect the levels of ambient light, and store the current levels of ambient light in the memory.

6. The data protecting system of claim 1, wherein the user characteristics are user's fingerprint and/or facial features.

7. The data protecting system of claim 6, wherein the user characteristic obtaining unit is a camera, for shooting images of the user's fingerprint and/or facial features.

8. The data protecting system of claim 1, wherein the authorized users' user characteristic is stored in the memory or in a network server which can be obtained via network.

9. A data protecting method implemented by an electronic device comprising:
periodically obtaining current environmental characteristics around the electronic device and store the current environmental characteristics in a memory;
comparing the current environmental characteristics with previous environmental characteristics to determine whether the current environmental characteristics change;
obtaining user characteristics of a user when the environmental characteristics changes;
comparing the user characteristics with authorized users' user characteristics to determine if the user is authorized, and
implementing data protection when the user is unauthorized.

10. The data protecting method of claim 9, wherein the step of implementing data protection when the user is unauthorized comprises locking a display and/or an input unit to prevent any operation by the user.

11. The data protecting method of claim 9, wherein the step of implementing data protection when the user is unauthorized comprises deleting the data in the memory or performing read and write protection of the data in the memory if any external device is connected with an interface.

12. The data protecting method of claim 9, wherein the current environmental characteristics are levels of ambient light.

13. The data protecting method of claim 9, wherein the user characteristics are user's fingerprint and/or facial features.

14. The data protecting method of claim 13, wherein the user characteristic obtaining unit is a camera for shooting images of the user's fingerprint and/or facial features.

15. The data protecting method of claim 9, wherein the authorized users' user characteristics are stored in the memory or in a network server which can be obtained via network.
